(19) United States
(12) Patent Application Publication
(10) Pub. No.: US 2012/0229902 A1
(43) Pub. Date: Sep. 13, 2012

(54) Zoom Lens System, Imaging Device and Camera

(75) Inventor: Yoshio Matsumura, Osaka (JP)

(73) Assignee: PANASONIC CORPORATION, Osaka (JP)

(21) Appl. No.: 13/413,673

(22) Filed: Mar. 7, 2012

(30) Foreign Application Priority Data
Mar. 7, 2011 (JP) 2011-048697
Jan. 18, 2012 (JP) 2012-008494

(51) Int. Cl. G02B 15/14

(52) U.S. Cl. 359/557; 359/683

(57) ABSTRACT

A zoom lens system, in order from an object side to an image side, comprising: a first lens unit having negative optical power; a second lens unit having positive optical power; a third lens unit having negative optical power; and a subsequent lens unit containing at least a fourth lens unit, wherein in zooming from a wide-angle limit to a telephoto limit at the time of image taking, intervals between the individual lens units vary and the fourth lens unit is fixed relative to an image surface, and wherein the conditions: vd_{4G}<40 and ω_{w}>34 (vd_{4G}: an Abbe number to the d-line of a lens element constituting the fourth lens unit, ω_{w}: a half view angle at a wide-angle limit) are satisfied; an imaging device; and a camera are provided.

### CROSS-REFERENCE TO RELATED APPLICATION

This application is based on application No. 2011-048697 filed in Japan on Mar. 7, 2011 and application No. 2012-008494 filed in Japan on Jan. 18, 2012, the contents of which are hereby incorporated by reference.

### BACKGROUND OF THE INVENTION

1. Field of the Invention

The present invention relates to zoom lens systems, imaging devices, and cameras. In particular, the present invention relates to: a zoom lens system having, as well as a high resolution, a small size and still having a view angle of about 70° or more at a wide-angle limit, which is satisfactorily adaptable for wide-angle image taking, and further having a relatively high zooming ratio of about 3 or more; an imaging device employing the zoom lens system; and a compact camera employing the imaging device.

2. Description of the Background Art

With recent progress in the development of solid-state image sensors such as a CCD (Charge Coupled Device) and a CMOS (Complementary Metal-Oxide Semiconductor) having a high pixel density, digital still cameras and digital video cameras (simply referred to as “digital cameras”, hereinafter) are rapidly spreading that employ an imaging device including an imaging optical system of high optical performance corresponding to the above-mentioned solid-state image sensors of a high pixel density. Among the digital cameras of high optical performance, in particular, from a convenience point of view, compact cameras are strongly requested that employ a zoom lens system having a high zooming ratio and still being able to cover a wide focal-length range from a wide-angle condition to a high telephoto condition in its own right. On the other hand, zoom lens systems are also desired that have a wide-angle range where the photographing field is large.

Various kinds of zoom lenses as follows are proposed for the above-mentioned compact digital cameras.

Japanese Laid-Open Patent Publication No. 2005-055496 discloses a zoom lens, in order from the object side to the image side, comprising four lens units of negative, positive, negative, and positive, wherein the intervals of the individual lens units vary in zooming, and the front principal points position of the second lens unit is located on the object side relative to the second lens unit.

Japanese Laid-Open Patent Publication No. 2006-208889 discloses a zoom lens, in order from the object side to the image side, comprising four lens units of negative, positive, negative, and positive, wherein the intervals of the individual lens units vary in zooming, the interval between the second lens unit and the third lens unit and the interval between the third lens unit and the fourth lens unit satisfy a particular condition, and the radius of curvature of a lens element constituting the third lens unit satisfies a particular condition.

Japanese Laid-Open Patent Publication No. 2008-129456 discloses a zoom lens, in order from the object side to the image side, comprising four lens units of negative, positive, negative, and positive, wherein the intervals of the individual lens units vary in zooming, and the focal length of the entire system at a wide-angle limit and the interval between the third lens unit and the fourth lens unit satisfies a particular condition.

Japanese Laid-Open Patent Publication No. 2010-134473 discloses a zoom lens, in order from the object side to the image side, comprising four lens units of negative, positive, negative, and positive, wherein the intervals of the individual lens units vary in zooming, a condition for the configuration of the second lens unit is satisfied, and a particular condition is satisfied between the focal length of the second lens unit and the focal length of the entire system at a wide-angle limit.

Japanese Laid-Open Patent Publication No. 2010-160198 discloses a zoom lens, in order from the object side to the image side, comprising four lens units of negative, positive, negative, and positive, wherein the intervals of the individual lens units vary in zooming, a condition for the configuration of the second lens unit is satisfied, and the radius of curvature of a cemented surface of a cemented lens constituting the second lens unit and the focal length of the second lens unit satisfy a particular condition.

However, the zoom lenses disclosed in the above-mentioned patent documents have a relatively small zooming ratio in spite of a long overall length of lens system, and therefore do not satisfy the requirements for digital cameras in recent years.

### SUMMARY OF THE INVENTION

An object of the present invention is to provide: a zoom lens system having, as well as a high resolution, a small size and still having a view angle of about 70° or more at a wide-angle limit, which is satisfactorily adaptable for wide-angle image taking, and further having a relatively high zooming ratio of about 3 or more; an imaging device employing this zoom lens system; and a compact camera employing this imaging device.

The novel concepts disclosed herein were achieved in order to solve the foregoing problems in the conventional art, and herein is disclosed:

a zoom lens system having a plurality of lens units, each lens unit being composed of at least one lens element, the zoom lens system, in order from an object side to an image side, comprising:

a first lens unit having negative optical power;

a second lens unit having positive optical power;

a third lens unit having negative optical power; and

a subsequent lens unit containing at least a fourth lens unit, wherein

in zooming from a wide-angle limit to a telephoto limit at the time of image taking, intervals between the individual lens units vary and the fourth lens unit is fixed relative to an image surface, and wherein

the following conditions (1) and (2) are satisfied:

vd_{4G}<40 (1)

ω_{w}>34 (2)

where,

vd_{4G} is an Abbe number to the d-line of a lens element constituting the fourth lens unit, and

ω_{w} is a half view angle (°) at a wide-angle limit.

The novel concepts disclosed herein were achieved in order to solve the foregoing problems in the conventional art, and herein is disclosed:

an imaging device capable of outputting an optical image of an object as an electric image signal, comprising:

a zoom lens system that forms an optical image of the object; and

an image sensor that converts the optical image formed by the zoom lens system into the electric image signal, wherein

the zoom lens system is a zoom lens system having a plurality of lens units, each lens unit being composed of at least one lens element, the zoom lens system, in order from an object side to an image side, comprising:

a first lens unit having negative optical power;

a second lens unit having positive optical power;

a third lens unit having negative optical power; and

a subsequent lens unit containing at least a fourth lens unit, wherein

in zooming from a wide-angle limit to a telephoto limit at the time of image taking, intervals between the individual lens units vary and the fourth lens unit is fixed relative to an image surface, and wherein

the following conditions (1) and (2) are satisfied:

vd_{4G}<40 (1)

ω_{w}>34 (2)

where,

vd_{4G} is an Abbe number to the d-line of a lens element constituting the fourth lens unit, and

ω_{w} is a half view angle (°) at a wide-angle limit.

The novel concepts disclosed herein were achieved in order to solve the foregoing problems in the conventional art, and herein is disclosed:

a camera for converting an optical image of an object into an electric image signal and then performing at least one of displaying and storing of the converted image signal, comprising

an imaging device including a zoom lens system that forms an optical image of the object and an image sensor that converts the optical image formed by the zoom lens system into the electric image signal, wherein

the zoom lens system is a zoom lens system having a plurality of lens units, each lens unit being composed of at least one lens element, the zoom lens system, in order from an object side to an image side, comprising:

a first lens unit having negative optical power;

a second lens unit having positive optical power;

a third lens unit having negative optical power; and

a subsequent lens unit containing at least a fourth lens unit, wherein

in zooming from a wide-angle limit to a telephoto limit at the time of image taking, intervals between the individual lens units vary and the fourth lens unit is fixed relative to an image surface, and wherein

the following conditions (1) and (2) are satisfied:

vd_{4G}<40 (1)

ω_{w}>34 (2)

where,

vd_{4G} is an Abbe number to the d-line of a lens element constituting the fourth lens unit, and

ω_{w} is a half view angle (°) at a wide-angle limit.

According to the present invention, a zoom lens system can be provided that has, as well as a high resolution, a small size and still has a view angle of about 70° or more at a wide-angle limit, which is satisfactorily adaptable for wide-angle image taking, and that further has a relatively high zooming ratio of about 3 or more. Further, according to the present invention, an imaging device employing the zoom lens system and a thin and very compact camera employing the imaging device can be provided.

### BRIEF DESCRIPTION OF THE DRAWINGS

This and other objects and features of this invention will become clear from the following description, taken in conjunction with the preferred embodiments with reference to the accompanied drawings in which:

FIG. 1 is a lens arrangement diagram showing an infinity in-focus condition of a zoom lens system according to Embodiment 1 (Example 1);

FIG. 2 is a longitudinal aberration diagram of an infinity in-focus condition of a zoom lens system according to Example 1;

FIG. 3 is a lateral aberration diagram of a zoom lens system according to Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Example 2);

FIG. 5 is a longitudinal aberration diagram of an infinity in-focus condition of a zoom lens system according to Example 2;

FIG. 6 is a lateral aberration diagram of a zoom lens system according to Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Example 3);

FIG. 8 is a longitudinal aberration diagram of an infinity in-focus condition of a zoom lens system according to Example 3;

FIG. 9 is a lateral aberration diagram of a zoom lens system according to Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Example 4);

FIG. 11 is a longitudinal aberration diagram of an infinity in-focus condition of a zoom lens system according to Example 4;

FIG. 12 is a lateral aberration diagram of a zoom lens system according to Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Example 5);

FIG. 14 is a longitudinal aberration diagram of an infinity in-focus condition of a zoom lens system according to Example 5;

FIG. 15 is a lateral aberration diagram of a zoom lens system according to Example 5 at a telephoto limit in a basic state where image blur compensation is not performed and in an image blur compensation state; and

FIG. 16 is a schematic construction diagram of a digital still camera according to Embodiment 6.

### DESCRIPTION OF THE PREFERRED EMBODIMENTS

### Embodiments 1 to 5

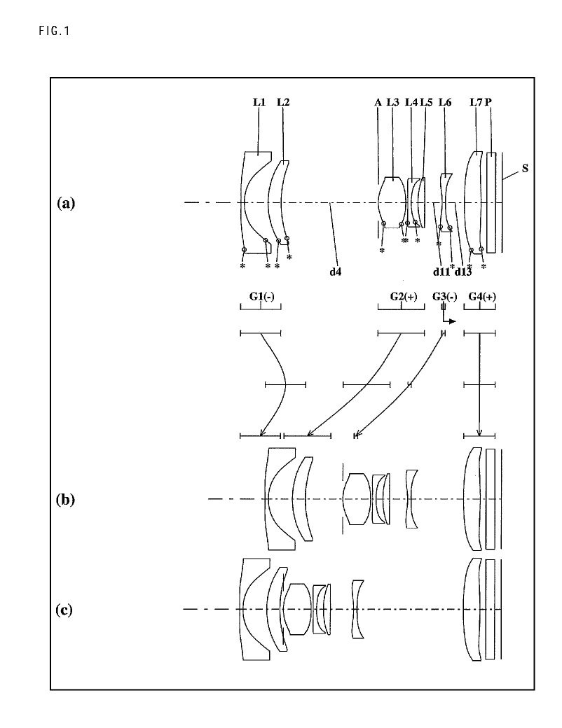

FIGS. 1, 4, 7, 10 and 13 are lens arrangement diagrams of zoom lens systems according to Embodiments 1 to 5, respectively.

Each of FIGS. 1, 4, 7, 10 and 13 shows a zoom lens system in an infinity in-focus condition. In each Fig., part (a) shows a lens configuration at a wide-angle limit (in the minimum focal length condition: focal length f_{w}), part (b) shows a lens configuration at a middle position (in an intermediate focal length condition: focal length f_{M}=√(f_{w}*f_{T})), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, the arrow indicates the moving direction at the time of focusing from an infinity in-focus condition to a close-object in-focus condition.

Further, in FIGS. 1, 4, 7, 10 and 13, an asterisk “*” imparted to a particular surface indicates that the surface is aspheric. In each Fig., symbol (+) or (−) imparted to the symbol of each lens unit corresponds to the sign of the optical power of the lens unit. Further, in each Fig., a straight line located closest to the right-hand side indicates the position of the image surface S. On the object side of the image surface S (that is, between the image surface S and the most image side lens surface of the fourth lens unit G4), a plane parallel plate P equivalent to an optical low-pass filter or a face plate of an image sensor is provided.

Further, in FIGS. 1, 4, 7, 10 and 13, an aperture diaphragm A is provided closest to the object side in the second lens unit G2, that is, between the first lens unit G1 and the second lens unit G2.

As shown in FIG. 1, in the zoom lens system according to Embodiment 1, the first lens unit G1, in order from the object side to the image side, comprises: a bi-concave first lens element L1; and a positive meniscus second lens element L2 with the convex surface facing the object side. The first lens element L1 has two aspheric surfaces, and the second lens element L2 also has two aspheric surfaces.

In the zoom lens system according to Embodiment 1, the second lens unit G2, in order from the object side to the image side, comprises: a bi-convex third lens element L3; a bi-concave fourth lens element L4; and a bi-convex fifth lens element L5. The third lens element L3 has two aspheric surfaces, and the fourth lens element L4 also has two aspheric surfaces.

In the zoom lens system according to Embodiment 1, the third lens unit G3 comprises solely a bi-concave sixth lens element L6. The sixth lens element L6 has two aspheric surfaces.

In the zoom lens system according to Embodiment 1, the fourth lens unit G4 comprises solely a bi-convex seventh lens element L7. The seventh lens element L7 has two aspheric surfaces.

In the zoom lens system according to Embodiment 1, a plane parallel plate P is provided on the object side relative to the image surface S (between the image surface S and the seventh lens element L7).

In the zoom lens system according to Embodiment 1, in zooming from a wide-angle limit to a telephoto limit at the time of image taking, the first lens unit G1 moves with locus of a convex to the image side, the second lens unit G2 moves to the object side, the third lens unit G3 moves to the object side, and the fourth lens unit G4 does not move. That is, in zooming, the first lens unit G1, the second lens unit G2, and the third lens unit G3 move individually along the optical axis such that the interval between the first lens unit G1 and the second lens unit G2 should decrease, and that the interval between the third lens unit G3 and the fourth lens unit G4 should increase. Further, the aperture diaphragm A moves together with the second lens unit G2 to the object side along the optical axis.

In the zoom lens system according to Embodiment 1, the third lens element L3 and the fourth lens element L4 correspond to an escaping lens unit described later. Then, at the time of retracting, the third lens element L3 and the fourth lens element L4 escape along an axis different from that at the time of image taking

Further, in the zoom lens system according to Embodiment 1, in focusing from an infinity in-focus condition to a close-object in-focus condition, the third lens unit G3 moves to the image side along the optical axis.

Further, in the zoom lens system according to Embodiment 1, the fifth lens element L5 corresponds to an image blur compensating lens unit described later. Then, by moving the fifth lens element L5 in a direction perpendicular to the optical axis, image point movement caused by vibration of the entire system can be compensated, that is, image blur caused by hand blur, vibration, and the like can be compensated optically.

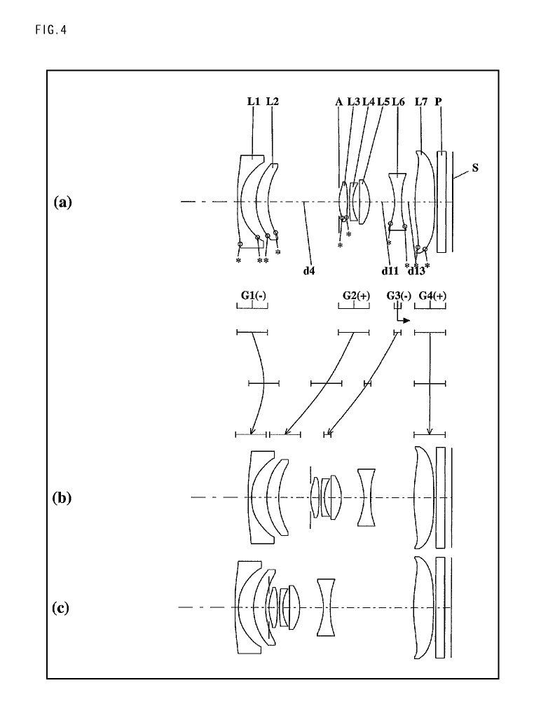

As shown in FIG. 4, in the zoom lens system according to Embodiment 2, the first lens unit G1, in order from the object side to the image side, comprises: a negative meniscus first lens element L1 with the convex surface facing the object side; and a positive meniscus second lens element L2 with the convex surface facing the object side. The first lens element L1 has two aspheric surfaces, and the second lens element L2 also has two aspheric surfaces.

In the zoom lens system according to Embodiment 2, the second lens unit G2, in order from the object side to the image side, comprises: a bi-convex third lens element L3; a negative meniscus fourth lens element L4 with the convex surface facing the object side; and a positive meniscus fifth lens element L5 with the convex surface facing the image side. The third lens element L3 has two aspheric surfaces.

In the zoom lens system according to Embodiment 2, the third lens unit G3 comprises solely a bi-concave sixth lens element L6. The sixth lens element L6 has two aspheric surfaces.

In the zoom lens system according to Embodiment 2, the fourth lens unit G4 comprises solely a bi-convex seventh lens element L7. The seventh lens element L7 has two aspheric surfaces.

In the zoom lens system according to Embodiment 2, a plane parallel plate P is provided on the object side relative to the image surface S (between the image surface S and the seventh lens element L7).

In the zoom lens system according to Embodiment 2, in zooming from a wide-angle limit to a telephoto limit at the time of image taking, the first lens unit G1 moves to the object side with locus of a convex to the image side, the second lens unit G2 moves to the object side, the third lens unit G3 moves to the object side, and the fourth lens unit G4 does not move. That is, in zooming, the first lens unit G1, the second lens unit G2, and the third lens unit G3 move individually along the optical axis such that the interval between the first lens unit G1 and the second lens unit G2 should decrease, and that the interval between the third lens unit G3 and the fourth lens unit G4 should increase. Further, the aperture diaphragm A moves together with the second lens unit G2 to the object side along the optical axis.

In the zoom lens system according to Embodiment 2, the second lens unit G2 corresponds to an escaping lens unit described later. Then, at the time of retracting, the second lens unit G2 escapes along an axis different from that at the time of image taking

Further, in the zoom lens system according to Embodiment 2, in focusing from an infinity in-focus condition to a close-object in-focus condition, the third lens unit G3 moves to the image side along the optical axis.

Further, in the zoom lens system according to Embodiment 2, the third lens unit G3 corresponds to an image blur compensating lens unit described later. Then, by moving the third lens unit G3 in a direction perpendicular to the optical axis, image point movement caused by vibration of the entire system can be compensated, that is, image blur caused by hand blur, vibration, and the like can be compensated optically.

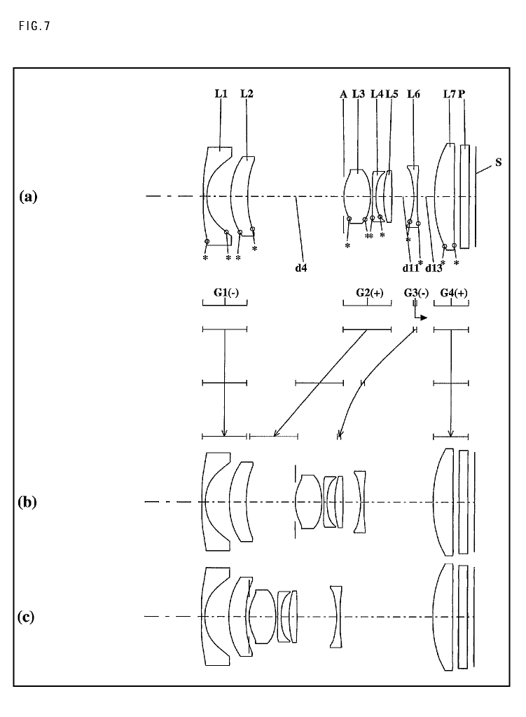

As shown in FIG. 7, in the zoom lens system according to Embodiment 3, the first lens unit G1, in order from the object side to the image side, comprises: a negative meniscus first lens element L1 with the convex surface facing the object side; and a positive meniscus second lens element L2 with the convex surface facing the object side. The first lens element L1 has two aspheric surfaces, and the second lens element L2 also has two aspheric surfaces.

In the zoom lens system according to Embodiment 3, the second lens unit G2, in order from the object side to the image side, comprises: a bi-convex third lens element L3; a bi-concave fourth lens element L4; and a bi-convex fifth lens element L5. The third lens element L3 has two aspheric surfaces, and the fourth lens element L4 also has two aspheric surfaces.

In the zoom lens system according to Embodiment 3, the third lens unit G3 comprises solely a negative meniscus sixth lens element L6 with the convex surface facing the image side. The sixth lens element L6 has two aspheric surfaces.

In the zoom lens system according to Embodiment 3, the fourth lens unit G4 comprises solely a bi-convex seventh lens element L7. The seventh lens element L7 has two aspheric surfaces.

In the zoom lens system according to Embodiment 3, a plane parallel plate P is provided on the object side relative to the image surface S (between the image surface S and the seventh lens element L7).

In the zoom lens system according to Embodiment 3, in zooming from a wide-angle limit to a telephoto limit at the time of image taking, the first lens unit G1 does not move, the second lens unit G2 moves to the object side, the third lens unit G3 moves to the object side, and the fourth lens unit G4 does not move. That is, in zooming, the second lens unit G2 and the third lens unit G3 move individually along the optical axis such that the interval between the first lens unit G1 and the second lens unit G2 should decrease, and that the interval between the third lens unit G3 and the fourth lens unit G4 should increase. Further, the aperture diaphragm A moves together with the second lens unit G2 to the object side along the optical axis.

In the zoom lens system according to Embodiment 3, the third lens element L3 and the fourth lens element L4 correspond to an escaping lens unit described later. Then, at the time of retracting, the third lens element L3 and the fourth lens element L4 escape along an axis different from that at the time of image taking

Further, in the zoom lens system according to Embodiment 3, in focusing from an infinity in-focus condition to a close-object in-focus condition, the third lens unit G3 moves to the image side along the optical axis.

Further, in the zoom lens system according to Embodiment 3, the fifth lens element L5 corresponds to an image blur compensating lens unit described later. Then, by moving the fifth lens element L5 in a direction perpendicular to the optical axis, image point movement caused by vibration of the entire system can be compensated, that is, image blur caused by hand blur, vibration, and the like can be compensated optically.

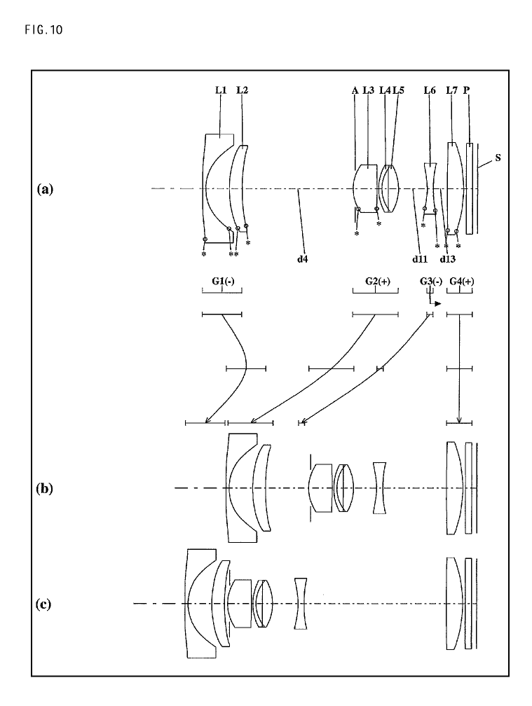

As shown in FIG. 10, in the zoom lens system according to Embodiment 4, the first lens unit G1, in order from the object side to the image side, comprises: a negative meniscus first lens element L1 with the convex surface facing the object side; and a positive meniscus second lens element L2 with the convex surface facing the object side. The first lens element L1 has two aspheric surfaces, and the second lens element L2 also has two aspheric surfaces.

In the zoom lens system according to Embodiment 4, the second lens unit G2, in order from the object side to the image side, comprises: a bi-convex third lens element L3; a negative meniscus fourth lens element L4 with the convex surface facing the object side; and a bi-convex fifth lens element L5. The third lens element L3 has two aspheric surfaces.

In the zoom lens system according to Embodiment 4, the third lens unit G3 comprises solely a bi-concave sixth lens element L6. The sixth lens element L6 has two aspheric surfaces.

In the zoom lens system according to Embodiment 4, the fourth lens unit G4 comprises solely a positive meniscus seventh lens element L7 with the convex surface facing the image side. The seventh lens element L7 has two aspheric surfaces.

In the zoom lens system according to Embodiment 4, a plane parallel plate P is provided on the object side relative to the image surface S (between the image surface S and the seventh lens element L7).

In the zoom lens system according to Embodiment 4, in zooming from a wide-angle limit to a telephoto limit at the time of image taking, the first lens unit G1 moves to the object side with locus of a convex to the image side, the second lens unit G2 moves to the object side, the third lens unit G3 moves to the object side, and the fourth lens unit G4 does not move. That is, in zooming, the first lens unit G1, the second lens unit G2, and the third lens unit G3 move individually along the optical axis such that the interval between the first lens unit G1 and the second lens unit G2 should decrease, and that the interval between the third lens unit G3 and the fourth lens unit G4 should increase. Further, the aperture diaphragm A moves together with the second lens unit G2 to the object side along the optical axis.

In the zoom lens system according to Embodiment 4, the second lens unit G2 corresponds to an escaping lens unit described later. Then, at the time of retracting, the second lens unit G2 escapes along an axis different from that at the time of image taking

Further, in the zoom lens system according to Embodiment 4, in focusing from an infinity in-focus condition to a close-object in-focus condition, the third lens unit G3 moves to the image side along the optical axis.

Further, in the zoom lens system according to Embodiment 4, the third lens unit G3 corresponds to an image blur compensating lens unit described later. Then, by moving the third lens unit G3 in a direction perpendicular to the optical axis, image point movement caused by vibration of the entire system can be compensated, that is, image blur caused by hand blur, vibration, and the like can be compensated optically.

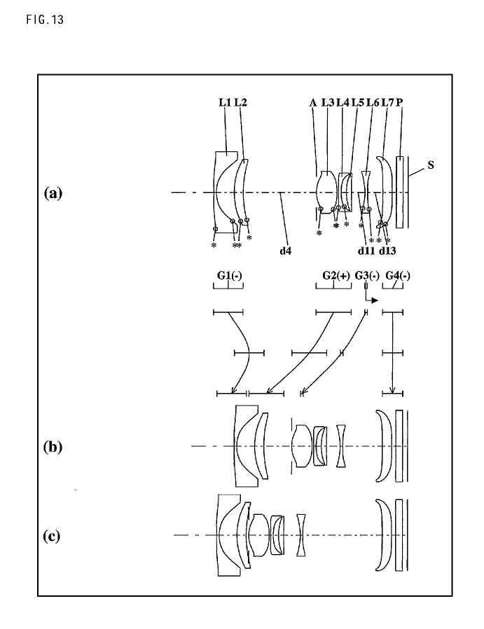

As shown in FIG. 13, in the zoom lens system according to Embodiment 5, the first lens unit G1, in order from the object side to the image side, comprises: a bi-concave first lens element L1; and a positive meniscus second lens element L2 with the convex surface facing the object side. The first lens element L1 has two aspheric surfaces, and the second lens element L2 also has two aspheric surfaces.

In the zoom lens system according to Embodiment 5, the second lens unit G2, in order from the object side to the image side, comprises: a bi-convex third lens element L3; a bi-concave fourth lens element L4; and a positive meniscus fifth lens element L5 with the convex surface facing the object side. The third lens element L3 has two aspheric surfaces, and the fourth lens element L4 also has two aspheric surfaces.

In the zoom lens system according to Embodiment 5, the third lens unit G3 comprises solely a bi-concave sixth lens element L6. The sixth lens element L6 has two aspheric surfaces.

In the zoom lens system according to Embodiment 5, the fourth lens unit G4 comprises solely a bi-concave seventh lens element L7. The seventh lens element L7 has two aspheric surfaces.

In the zoom lens system according to Embodiment 5, a plane parallel plate P is provided on the object side relative to the image surface S (between the image surface S and the seventh lens element L7).

In the zoom lens system according to Embodiment 5, in zooming from a wide-angle limit to a telephoto limit at the time of image taking, the first lens unit G1 moves to the image side with locus of a convex to the image side, the second lens unit G2 moves to the object side, the third lens unit G3 moves to the object side, and the fourth lens unit G4 does not move. That is, in zooming, the first lens unit G1, the second lens unit G2, and the third lens unit G3 move individually along the optical axis such that the interval between the first lens unit G1 and the second lens unit G2 should decrease, and that the interval between the third lens unit G3 and the fourth lens unit G4 should increase. Further, the aperture diaphragm A moves together with the second lens unit G2 to the object side along the optical axis.

In the zoom lens system according to Embodiment 5, the second lens unit G2 corresponds to an escaping lens unit described later. Then, at the time of retracting, the second lens unit G2 escapes along an axis different from that at the time of image taking

Further, in the zoom lens system according to Embodiment 5, in focusing from an infinity in-focus condition to a close-object in-focus condition, the third lens unit G3 moves to the image side along the optical axis.

Further, in the zoom lens system according to Embodiment 5, the third lens unit G3 corresponds to an image blur compensating lens unit described later. Then, by moving the third lens unit G3 in a direction perpendicular to the optical axis, image point movement caused by vibration of the entire system can be compensated, that is, image blur caused by hand blur, vibration, and the like can be compensated optically.

The following description is given for conditions preferred to be satisfied by a zoom lens system like the zoom lens systems according to Embodiments 1 to 5. Here, a plurality of preferable conditions are set forth for the zoom lens system according to each embodiment. A construction that satisfies all the plural conditions is most desirable for the zoom lens system. However, when an individual condition is satisfied, a zoom lens system having the corresponding effect is obtained.

For example, in a zoom lens system like the zoom lens systems according to Embodiments 1 to 5, having a plurality of lens units, each lens unit being composed of at least one lens element, the zoom lens system, in order from an object side to an image side, comprising: a first lens unit having negative optical power; a second lens unit having positive optical power; a third lens unit having negative optical power; and a subsequent lens unit containing at least a fourth lens unit, wherein in zooming from a wide-angle limit to a telephoto limit at the time of image taking, the intervals between the individual lens units vary and the fourth lens unit is fixed relative to the image surface (this lens configuration is referred to as basic configuration of the embodiment, hereinafter), the following conditions (1) and (2) are satisfied.

vd_{4G}<40 (1)

ω_{w}>34 (2)

where,

vd_{4G} is an Abbe number to the d-line of a lens element constituting the fourth lens unit, and

ω_{w} is a half view angle (°) at a wide-angle limit.

The condition (1) sets forth the Abbe number of the lens element constituting the fourth lens unit. When the condition (1) is not satisfied, control of magnification chromatic aberration at a wide-angle limit becomes difficult.

When the following condition (1)′ is satisfied, the above-mentioned effect is achieved more successfully.

vd_{4G}<30 (1)

In a zoom lens system having the basic configuration like the zoom lens systems according to Embodiments 1 to 5, it is preferable that the following condition (3) is satisfied.

3<f_{w}/T_{L1}<70 (3)

where,

f_{w} is a focal length of the entire system at a wide-angle limit, and

T_{L1} is an optical axial thickness of a lens element located closest to the object side among the lens elements constituting the first lens unit.

The condition (3) sets forth a relationship between the focal length of the entire system at a wide-angle limit and the optical axial thickness of the lens element, that is, the first lens element, located closest to the object side among the lens elements constituting the first lens unit. When the value exceeds the upper limit of the condition (3), the thickness of the first lens element becomes excessively small, and therefore its machining becomes difficult. On the other hand, when the value goes below the lower limit of the condition (3), control of astigmatism at a wide-angle limit becomes difficult.

When at least one of the following conditions (3)′ and (3)″ is satisfied, the above-mentioned effect is achieved more successfully.

10<f_{w}/T_{L1} (3)′

f_{w}/T_{L1}<25 (3)″

In a zoom lens system like the zoom lens systems according to Embodiments 1 to 5, having the basic configuration, and having: an escaping lens unit that, at the time of retracting, escapes along an axis different from that at the time of image taking; and an image blur compensating lens unit that moves in a direction perpendicular to the optical axis in order to optically compensate image blur, it is preferable that the following condition (4) is satisfied.

3.5<T_{ESC}/T_{OIS}<18.0 (4)

where,

T_{ESC} is an optical axial thickness of the escaping lens unit, and

T_{OIS} is an optical axial thickness of the image blur compensating lens unit.

The condition (4) sets forth a relationship between the optical axial thickness of the escaping lens unit and the optical axial thickness of the image blur compensating lens unit. When the value exceeds the upper limit of the condition (4), it becomes difficult to enhance the refractive power of the image blur compensating lens unit, and therefore the amount of movement in the direction perpendicular to the optical axis becomes excessively large. Thus, image blur compensation becomes difficult. On the other hand, when the value goes below the lower limit of the condition (4), the escaping lens unit becomes excessively thin. Thus, it becomes difficult to provide compact lens barrel, imaging device, and camera. Further, the diameter of the escaping lens unit becomes excessively large, and therefore control of curvature of field at a telephoto limit becomes difficult.

When at least one of the following conditions (4)′ and (4)″ is satisfied, the above-mentioned effect is achieved more successfully.

5<T_{ESC}/T_{OIS} (4)′

T_{ESC}/T_{OIs}<15 (4)″

In a zoom lens system having the basic configuration like the zoom lens systems according to Embodiments 1 to 5, it is preferable that the following condition (5) is satisfied.

−1.5<f_{G1}/(H_{T}×Z)<−0.3 (5)

where,

f_{G1} is a focal length of the first lens unit,

H_{T} is an image height at a telephoto limit,

Z is a value expressed by the following formula,

Z=f_{T}/f_{w}

f_{T} is a focal length of the entire system at a telephoto limit, and

f_{w} is a focal length of the entire system at a wide-angle limit.

The condition (5) sets forth a relationship among the focal length of the first lens unit, the image height at a telephoto limit, and the zooming ratio. When the value exceeds the upper limit of the condition (5), the overall length of lens system becomes excessively long for the zooming ratio. Thus, it becomes difficult to provide compact lens barrel, imaging device, and camera. Further, the diameter of the first lens unit becomes excessively large, and therefore control of distortion at a wide-angle limit becomes difficult. On the other hand, when the value goes below the lower limit of the condition (5), the refractive power of the first lens unit becomes excessively strong. Thus, control of fluctuation in astigmatism at a wide-angle limit and in spherical aberration associated with zooming becomes difficult.

When at least one of the following conditions (5)′ and (5)″ is satisfied, the above-mentioned effect is achieved more successfully.

−1.00<f_{G1}/(H_{T}×Z) (5)′

f_{G1}/(H_{T}×Z)<−0.45 (5)″

In a zoom lens system having the basic configuration like the zoom lens systems according to Embodiments 1 to 5, it is preferable that the following condition (6) is satisfied.

0.3<√(−f_{G1}×f_{G2})/(H_{T}×Z)<2.0 (6)

where,

f_{G1} is a focal length of the first lens unit,

f_{G2} is a focal length of the second lens unit,

H_{T} is an image height at a telephoto limit,

Z is a value expressed by the following formula,

Z=f_{T}/f_{w}

f_{T} is a focal length of the entire system at a telephoto limit, and

f_{w} is a focal length of the entire system at a wide-angle limit.

The condition (6) sets forth a relationship among the focal length of the first lens unit, the focal length of the second lens unit, the image height at a telephoto limit, and the zooming ratio. When the value exceeds the upper limit of the condition (6), the overall length of lens system becomes excessively long for the zooming ratio. Thus, it becomes difficult to provide compact lens barrel, imaging device, and camera. Further, the diameter of the first lens unit becomes excessively large, and therefore control of distortion at a wide-angle limit becomes difficult. On the other hand, when the value goes below the lower limit of the condition (6), the refractive power of each of the first lens unit and the second lens unit becomes excessively strong. Thus, control of fluctuation in astigmatism at a wide-angle limit and in spherical aberration associated with zooming becomes difficult.

When at least one of the following conditions (6)′ and (6)″ is satisfied, the above-mentioned effect is achieved more successfully.

0.4<√(−f_{G1}×f_{G2})/(H_{T}×Z) (6)′

√(−f_{G1}×f_{G2})/(H_{T}×Z)<1.2 (6)″

Like in the zoom lens systems according to Embodiments 1 to 5, it is preferable that the first lens unit is composed of two or more lens elements. When the first lens unit is composed of one lens element, control of astigmatism at a wide-angle limit becomes difficult.

Like in the zoom lens systems according to Embodiments 1 to 5, it is preferable that the lens unit located closest to the image side among the lens units constituting the subsequent lens unit is composed of one lens element. When the lens unit located closest to the image side is composed of a plurality of lens elements, control of fluctuation in astigmatism associated with zooming becomes difficult.

Further, like in the zoom lens systems according to Embodiments 1 to 5 where in zooming from a wide-angle limit to a telephoto limit at the time of image taking, the fourth lens unit is fixed relative to the image surface, it is preferable that the lens unit located closest to the image side among the lens units constituting the subsequent lens unit is fixed relative to the image surface in zooming. When the lens unit located closest to the image side moves along the optical axis in zooming, control of curvature of field at a wide-angle limit becomes difficult because it is necessary to widen intervals of the individual lens units.

Here, in the subsequent lens unit, as long as at least the fourth lens unit is included, the number of constituting lens units is not limited to a particular value. Further, the optical power of each lens unit is not limited to a particular kind

Each of the zoom lens systems according to Embodiments 1 to 5 is provided with a focusing lens unit that moves relative to the image surface in focusing from an infinity in-focus condition to a close-object in-focus condition. Then, it is preferable that the focusing lens unit moves to the image side along the optical axis in focusing. When the focusing lens unit moves to the object side in focusing, control of distortion at the time of short-distance image taking becomes difficult.

Further, like in the zoom lens systems according to Embodiments 1 to 5, it is preferable that the focusing lens unit is composed of one lens element. When the focusing lens unit is composed of a plurality of lens elements, the actuator for moving the focusing lens unit in the optical axis direction becomes excessively large. Thus, it becomes difficult to provide compact lens barrel, imaging device, and camera.

Each of the zoom lens systems according to Embodiments 1 to 5 is provided with an escaping lens unit that, at the time of retracting, escapes along an axis different from that at the time of image taking. As such, when at the time of retracting, the escaping lens unit escapes along the axis different from that at the time of image taking, further size reduction is achieved in the entire zoom lens system, and therefore more compact imaging device and camera can be realized. Here, the escaping lens unit may be composed of any one lens element or a plurality of adjacent lens elements among all the lens elements constituting the zoom lens system.

Each of the zoom lens systems according to Embodiments 1 to 5 is provided with an image blur compensating lens unit that moves in a direction perpendicular to the optical axis in order to optically compensate image blur. By virtue of the image blur compensating lens unit, image point movement caused by vibration of the entire system can be compensated. When compensating image point movement caused by vibration of the entire system, the image blur compensating lens unit moves in the direction perpendicular to the optical axis, so that image blur is compensated in a state that size increase in the entire zoom lens system is suppressed to realize a compact construction and that excellent imaging characteristics such as small decentering coma aberration and small decentering astigmatism are satisfied.

The image blur compensating lens unit may be composed of any one lens element or a plurality of adjacent lens elements among all the lens elements constituting the zoom lens system. However, it is preferable that the image blur compensating lens unit is composed of one lens element. When the image blur compensating lens unit is composed of a plurality of lens elements, the actuator for moving the image blur compensating lens unit in the direction perpendicular to the optical axis becomes excessively large. Thus, it becomes difficult to provide compact lens barrel, imaging device, and camera.

Each of the lens units constituting the zoom lens system according to any of Embodiments 1 to 5 is composed exclusively of refractive type lens elements that deflect the incident light by refraction (that is, lens elements of a type in which deflection is achieved at the interface between media each having a distinct refractive index). However, the present invention is not limited to this. For example, the lens units may employ diffractive type lens elements that deflect the incident light by diffraction; refractive-diffractive hybrid type lens elements that deflect the incident light by a combination of diffraction and refraction; or gradient index type lens elements that deflect the incident light by distribution of refractive index in the medium. In particular, in refractive-diffractive hybrid type lens elements, when a diffraction structure is formed in the interface between media having mutually different refractive indices, wavelength dependence in the diffraction efficiency is improved. Thus, such a configuration is preferable.

Moreover, in each embodiment, a configuration has been described that on the object side relative to the image surface S (that is, between the image surface S and the most image side lens surface of the fourth lens unit G4), a plane parallel plate P such as an optical low-pass filter and a face plate of an image sensor is provided. This low-pass filter may be: a birefringent type low-pass filter made of, for example, a crystal whose predetermined crystal orientation is adjusted; or a phase type low-pass filter that achieves required characteristics of optical cut-off frequency by diffraction.

### Embodiment 6

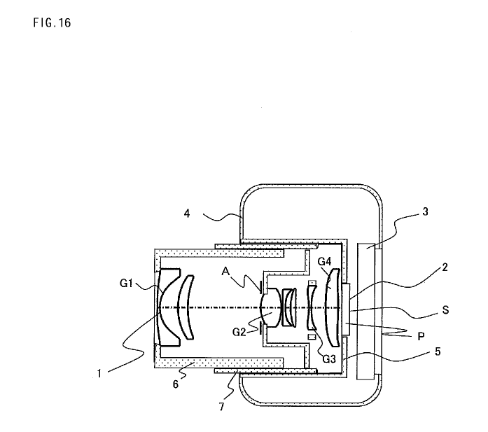

FIG. 16 is a schematic construction diagram of a digital still camera according to Embodiment 6. In FIG. 16, the digital still camera comprises: an imaging device having a zoom lens system 1 and an image sensor 2 composed of a CCD; a liquid crystal display monitor 3; and a body 4. The employed zoom lens system 1 is a zoom lens system according to Embodiment 1. In FIG. 16, the zoom lens system 1, in order from the object side to the image side, comprises a first lens unit G1, an aperture diaphragm A, a second lens unit G2, a third lens unit G3, and a fourth lens unit G4. In the body 4, the zoom lens system 1 is arranged on the front side, while the image sensor 2 is arranged on the rear side of the zoom lens system 1. On the rear side of the body 4, the liquid crystal display monitor 3 is arranged, while an optical image of a photographic object generated by the zoom lens system 1 is formed on an image surface S.

The lens barrel comprises a main barrel 5, a moving barrel 6 and a cylindrical cam 7. When the cylindrical cam 7 is rotated, the first lens unit G1, the aperture diaphragm A and the second lens unit G2, the third lens unit G3, and the fourth lens unit G4 move to predetermined positions relative to the image sensor 2, so that zooming from a wide-angle limit to a telephoto limit is achieved. The third lens unit G3 is movable in an optical axis direction by a motor for focus adjustment.

As such, when the zoom lens system according to Embodiment 1 is employed in a digital still camera, a small digital still camera is obtained that has a high resolution and high capability of compensating the curvature of field and that has a short overall length of lens system at the time of non-use. Here, in the digital still camera shown in FIG. 16, any one of the zoom lens systems according to Embodiments 2 to 5 may be employed in place of the zoom lens system according to Embodiment 1. Further, the optical system of the digital still camera shown in FIG. 16 is applicable also to a digital video camera for moving images. In this case, moving images with high resolution can be acquired in addition to still images.

Here, the digital still camera according to the present Embodiment 6 has been described for a case that the employed zoom lens system 1 is a zoom lens system according to Embodiments 1 to 5. However, in these zoom lens systems, the entire zooming range need not be used. That is, in accordance with a desired zooming range, a range where satisfactory optical performance is obtained may exclusively be used. Then, the zoom lens system may be used as one having a lower magnification than the zoom lens system described in Embodiments 1 to 5.

Further, Embodiment 6 has been described for a case that the zoom lens system is applied to a lens barrel of so-called barrel retraction construction. However, the present invention is not limited to this. For example, the zoom lens system may be applied to a lens barrel of so-called bending configuration where a prism having an internal reflective surface or a front surface reflective mirror is arranged at an arbitrary position within the first lens unit G1 or the like.

An imaging device comprising a zoom lens system according to Embodiments 1 to 5, and an image sensor such as a CCD or a CMOS may be applied to a mobile terminal device such as a smart-phone, a surveillance camera in a surveillance system, a Web camera, a vehicle-mounted camera or the like.

The following description is given for numerical examples in which the zoom lens system according to Embodiments 1 to 5 are implemented practically. In the numerical examples, the units of the length in the tables are all “mm”, while the units of the view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

K is a conic constant, and

Aₙ is a n-th order aspherical coefficient.

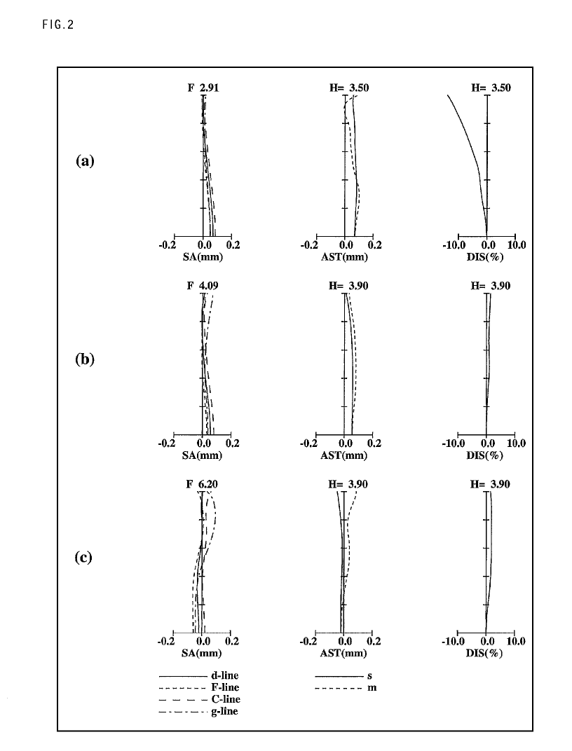

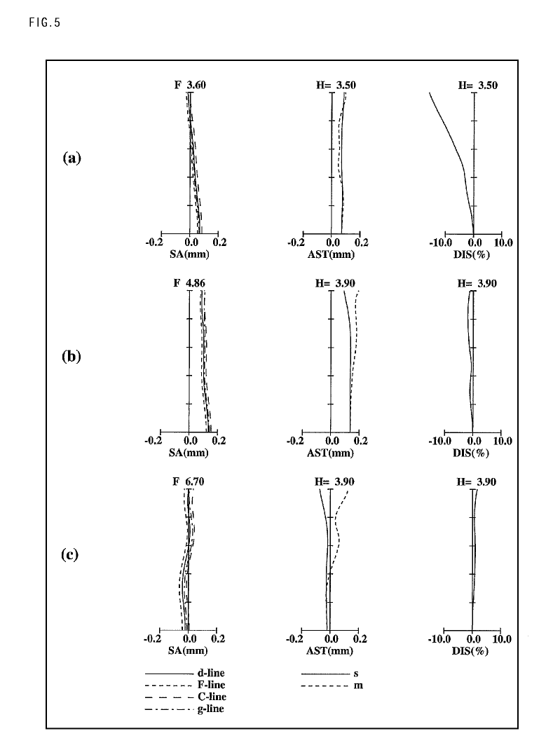

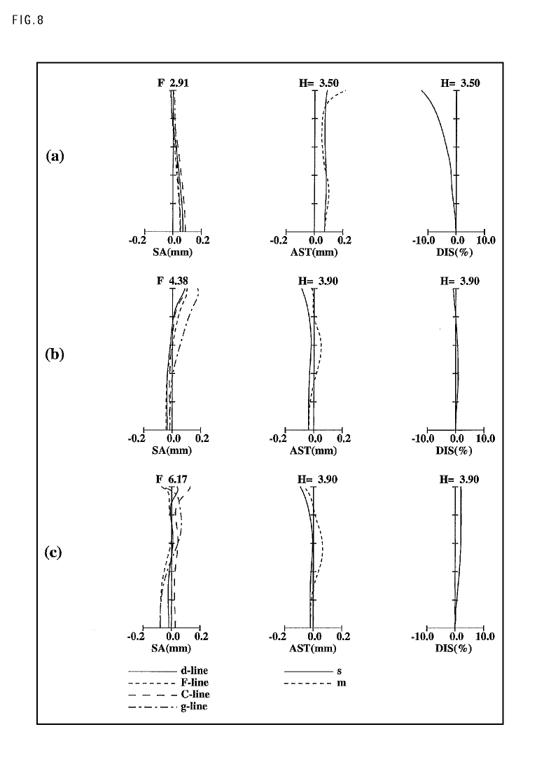

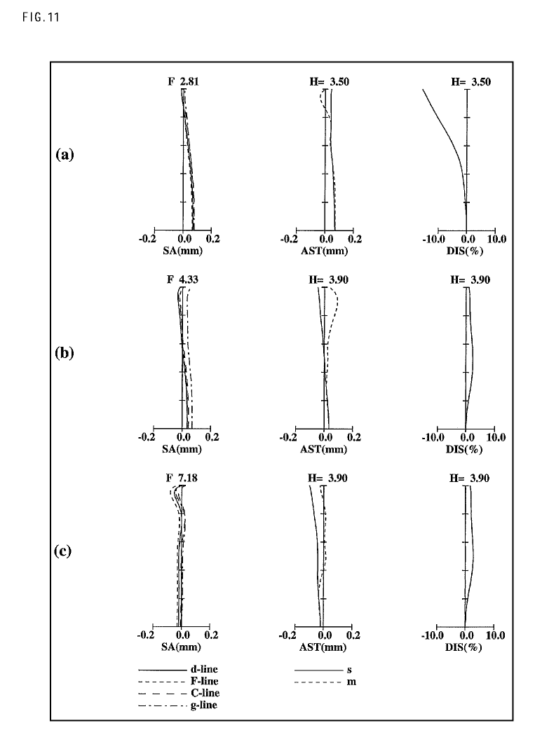

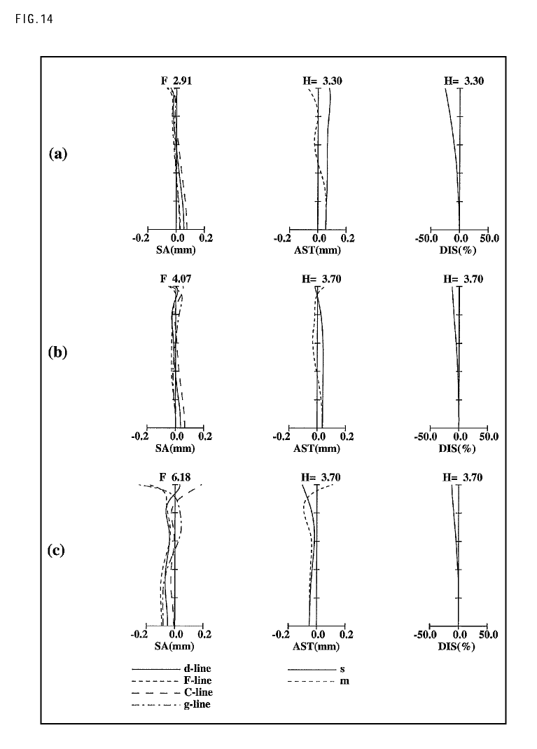

FIGS. 2, 5, 8, 11 and 14 are longitudinal aberration diagrams of an infinity in-focus condition of the zoom lens systems according to Numerical Examples 1 to 5, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line, the long dash line and the one-dot dash line indicate the characteristics to the d-line, the F-line, the C-line and the g-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

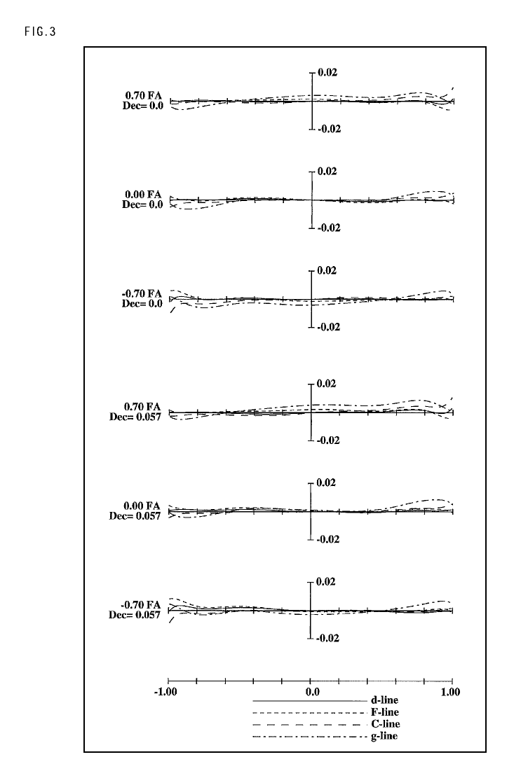

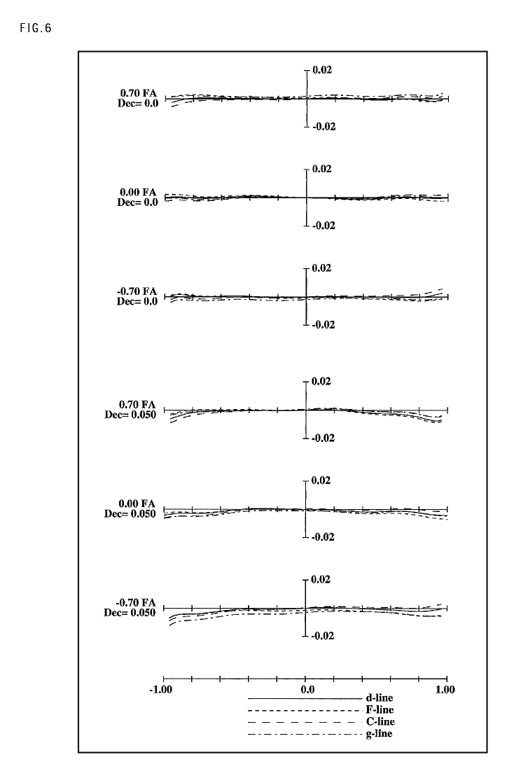

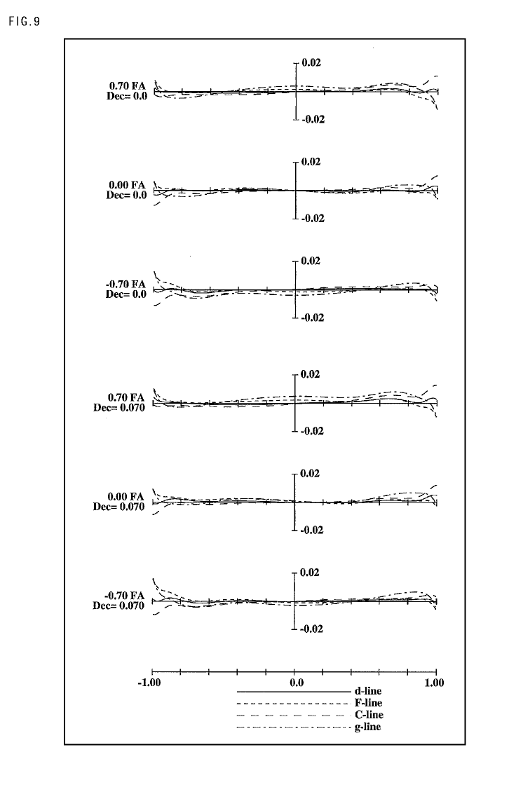

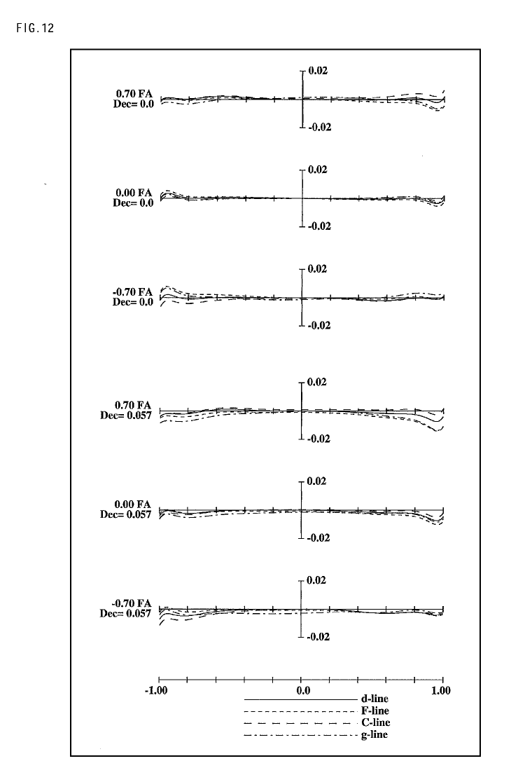

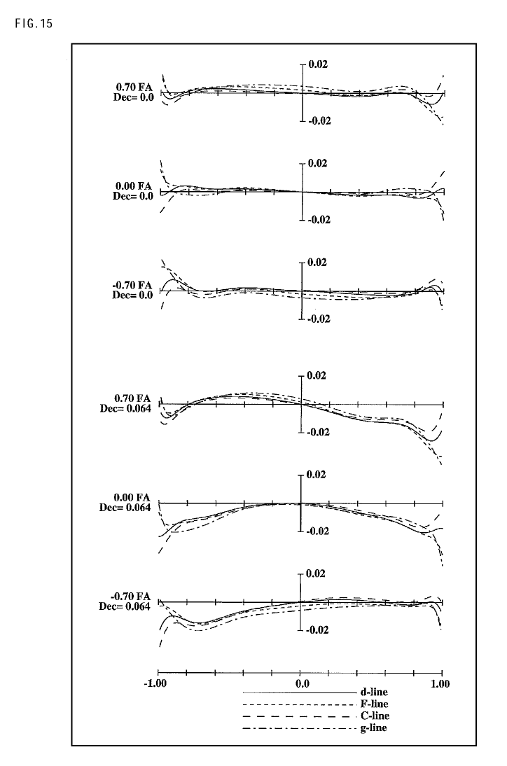

FIGS. 3, 6, 9, 12 and 15 are lateral aberration diagrams of the zoom lens systems at a telephoto limit according to Numerical Examples 1 to 5, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, the long dash line and the one-dot dash line indicate the characteristics to the d-line, the F-line, the C-line and the g-line, respectively. In each lateral aberration diagram, the meridional plane is adopted as the plane containing the optical axis of the first lens unit G1 and the optical axis of the second lens unit G2 (Numerical Examples 1 and 3) or the plane containing the optical axis of the first lens unit G1 and the optical axis of the third lens unit G3 (Numerical Examples 2, 4 and 5).

Here, in the zoom lens system according to each numerical example, the amount of movement of the image blur compensating lens unit in a direction perpendicular to the optical axis in an image blur compensation state at a telephoto limit is as follows.

| | |
|---|---|
| Numerical Example 1 | 0.057 mm |
| Numerical Example 2 | 0.050 mm |
| Numerical Example 3 | 0.070 mm |
| Numerical Example 4 | 0.057 mm |
| Numerical Example 5 | 0.064 mm |

Here, when the shooting distance is infinity, at a telephoto limit, the amount of image decentering in a case that the zoom lens system inclines by 0.3° is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd |
|---|---|---|---|---|
| Object surface | ∞ | | | |
| 1* | −359.60550 | 0.30000 | 1.77200 | 50.0 |
| 2* | 4.02310 | 2.09460 | | |
| 3* | 6.48890 | 1.14820 | 1.99537 | 20.7 |
| 4* | 9.12980 | Variable | | |
| 5(Diaphragm) | ∞ | 0.00000 | | |
| 6* | 3.37730 | 2.44380 | 1.58332 | 59.1 |
| 7* | −6.30220 | 0.17800 | | |
| 8* | −48.41230 | 0.30000 | 1.82115 | 24.1 |
| 9* | 6.12830 | 0.60000 | | |
| 10 | 6.42620 | 0.60000 | 1.51680 | 64.2 |
| 11 | −1659.68200 | Variable | | |
| 12* | −6.83570 | 0.30000 | 1.52996 | 55.8 |
| 13* | 17.73960 | Variable | | |
| 14* | 31.49690 | 1.47150 | 1.82115 | 24.1 |
| 15* | −21.53510 | 0.50000 | | |
| 16 | ∞ | 0.78000 | 1.51680 | 64.2 |
| 17 | ∞ | 0.57000 | | |
| 18 | ∞ | (BF) | | |
| Image surface | ∞ | | | |

TABLE 2
(Aspherical data)

Surface No. 1
K = 0.00000E+00, A4 = 3.69662E−03, A6 = −1.80951E−04, A8 = −3.78283E−06
A10 = 6.63662E−07, A12 = −2.60130E−08, A14 = 3.71831E−10, A16 = 0.00000E+00
Surface No. 2
K = 0.00000E+00, A4 = 2.13491E−03, A6 = 1.71448E−04, A8 = −1.07944E−05
A10 = −4.15904E−08, A12 = −1.98221E−07, A14 = 8.78874E−09, A16 = 0.00000E+00
Surface No. 3
K = 0.00000E+00, A4 = −1.89340E−03, A6 = 2.08864E−04, A8 = −3.94769E−07
A10 = −2.07826E−07, A12 = −2.70437E−08, A14 = 8.18299E−10, A16 = 0.00000E+00
Surface No. 4
K = 0.00000E+00, A4 = −1.54969E−03, A6 = 1.24773E−04, A8 = 1.42241E−06
A10 = 1.02403E−06, A12 = −2.62019E−07, A14 = 1.89164E−08, A16 = −5.23551E−10
Surface No. 6
K = 0.00000E+00, A4 = −1.86277E−03, A6 = −5.85070E−04, A8 = −4.13277E−05
A10 = −1.39514E−05, A12 = −3.93012E−06, A14 = −4.95330E−08, A16 = 0.00000E+00
Surface No. 7
K = 0.00000E+00, A4 = −3.53034E−03, A6 = −1.54566E−03, A8 = 1.15457E−04
A10 = 3.91782E−06, A12 = −4.12638E−07, A14 = −1.25637E−07, A16 = 0.00000E+00
Surface No. 8
K = 0.00000E+00, A4 = 7.42968E−06, A6 = 2.78695E−04, A8 = −3.30591E−05
A10 = 1.53087E−05, A12 = 1.76449E−06, A14 = 5.44738E−07, A16 = 0.00000E+00
Surface No. 9
K = 0.00000E+00, A4 = 7.41524E−03, A6 = 2.56661E−03, A8 = −1.08349E−04
A10 = 8.76510E−05, A12 = 0.00000E+00, A14 = 0.00000E+00, A16 = 0.00000E+00
Surface No. 12
K = 0.00000E+00, A4 = 5.79982E−03, A6 = 2.18610E−03, A8 = −4.84021E−04
A10 = 4.93644E−05, A12 = −4.82202E−07, A14 = −1.14823E−07, A16 = 0.00000E+00
Surface No. 13
K = 0.00000E+00, A4 = 9.18622E−03, A6 = 1.25179E−03, A8 = −3.22823E−04
A10 = 1.43559E−05, A12 = 1.91979E−06, A14 = −1.12307E−07, A16 = 0.00000E+00
Surface No. 14
K = 0.00000E+00, A4 = 2.94935E−03, A6 = −6.55155E−04, A8 = 8.34925E−05
A10 = −5.28798E−06, A12 = 1.74666E−07, A14 = −2.40145E−09, A16 = 6.34943E−13
Surface No. 15
K = 0.00000E+00, A4 = 5.97963E−03, A6 = −1.27695E−03, A8 = 1.45351E−04
A10 = −8.52781E−06, A12 = 2.55638E−07, A14 = −2.57251E−09, A16 = −2.50103E−11

TABLE 3
(Various data)
Zooming ratio 3.68791

| | Wide-angle | Middle | Telephoto |
|---|---|---|---|
| | limit | position | limit |
| Focal length | 3.7400 | 7.1824 | 13.7928 |
| F-number | 2.91314 | 4.08657 | 6.20201 |
| View angle | 47.4160 | 28.2055 | 15.5765 |
| Image height | 3.5000 | 3.9000 | 3.9000 |
| Overall length | 22.9999 | 20.7945 | 22.9999 |
| of lens system | | | |
| BF | 0.00000 | 0.00000 | 0.00000 |
| d4 | 8.5353 | 3.2927 | 0.3000 |
| d11 | 1.5319 | 1.5959 | 2.0493 |
| d13 | 1.6466 | 4.6198 | 9.3645 |
| Entrance pupil | 4.3925 | 3.2456 | 2.1008 |
| position | | | |
| Exit pupil | −10.1065 | −19.8501 | −87.9109 |
| position | | | |
| Front principal | 6.7580 | 7.8365 | 13.7291 |
| points position | | | |
| Back principal | 19.3299 | 13.6681 | 9.1872 |
| points position | | | |

Zoom lens unit data

| | | | Overall | Front | Back |
|---|---|---|---|---|---|
| | Initial | | length | principal | principal |
| Lens | surface | Focal | of lens | points | points |
| unit | No. | length | unit | position | position |
| 1 | 1 | −7.67353 | 3.54280 | −0.21986 | 0.51598 |
| 2 | 5 | 5.34067 | 4.12180 | 0.37903 | 1.41960 |
| 3 | 12 | −9.27155 | 0.30000 | 0.05431 | 0.15905 |
| 4 | 14 | 15.77336 | 2.75150 | 0.48597 | 1.40499 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd |
|---|---|---|---|---|
| Object surface | ∞ | | | |
| 1* | 5000.00000 | 0.30000 | 1.69385 | 53.1 |
| 2* | 5.04950 | 1.31560 | | |
| 3* | 4.82570 | 1.04520 | 2.00170 | 20.6 |
| 4* | 5.48600 | Variable | | |
| 5(Diaphragm) | ∞ | 0.00000 | | |
| 6* | 3.50000 | 0.73360 | 1.77200 | 50.0 |
| 7* | −14.98220 | 0.17800 | | |
| 8 | 13.45440 | 0.30000 | 1.84666 | 23.9 |
| 9 | 3.24120 | 0.60000 | | |
| 10 | −92.96640 | 0.89170 | 1.55920 | 53.9 |
| 11 | −3.56740 | Variable | | |
| 12* | −4.11740 | 0.60000 | 1.54410 | 56.1 |
| 13* | 17.15530 | Variable | | |
| 14* | 15.69950 | 1.73920 | 1.60740 | 27.0 |
| 15* | −24.47430 | 0.20000 | | |
| 16 | ∞ | 0.78000 | 1.51680 | 64.2 |
| 17 | ∞ | 0.57000 | | |
| 18 | ∞ | (BF) | | |
| Image surface | ∞ | | | |

TABLE 5
(Aspherical data)

Surface No. 1
K = 0.00000E+00, A4 = 5.25009E−03, A6 = −3.79468E−04, A8 = −1.07243E−06
A10 = 7.80087E−07, A12 = −1.72410E−08, A14 = 8.25336E−11, A16 = 0.00000E+00
Surface No. 2
K = 0.00000E+00, A4 = 5.05711E−03, A6 = 1.89000E−04, A8 = 6.16954E−07
A10 = −5.35252E−06, A12 = −1.60217E−07, A14 = 3.62208E−08, A16 = 0.00000E+00
Surface No. 3
K = 0.00000E+00, A4 = −2.60284E−03, A6 = 4.63035E−04, A8 = −2.79732E−05
A10 = 5.23007E−07, A12 = −3.56413E−08, A14 = 1.49396E−09, A16 = 0.00000E+00
Surface No. 4
K = 0.00000E+00, A4 = −2.59422E−03, A6 = 2.32359E−04, A8 = 1.85788E−05
A10 = −3.06425E−06, A12 = −1.96767E−07, A14 = 7.94057E−08, A16 = −5.84909E−09
Surface No. 6
K = 0.00000E+00, A4 = −3.29081E−03, A6 = −2.35445E−03, A8 = 1.15147E−03
A10 = −8.18555E−04, A12 = 1.21820E−04, A14 = −1.43496E−05, A16 = 0.00000E+00
Surface No. 7
K = 0.00000E+00, A4 = 1.84249E−03, A6 = −1.05935E−03, A8 = −4.00160E−04
A10 = −7.86912E−05, A12 = −6.33437E−05, A14 = 1.16757E−05, A16 = 0.00000E+00
Surface No. 12
K = 0.00000E+00, A4 = 1.40930E−02, A6 = −5.69665E−04, A8 = −9.13221E−04
A10 = 1.78885E−04, A12 = 1.93760E−05, A14 = −5.30406E−06, A16 = 0.00000E+00
Surface No. 13
K = 0.00000E+00, A4 = 1.29682E−02, A6 = −1.00505E−03, A8 = −4.48607E−04
A10 = 1.30364E−04, A12 = −9.35314E−06, A14 = −1.08217E−07, A16 = 0.00000E+00
Surface No. 14
K = 0.00000E+00, A4 = 2.15145E−03, A6 = −5.35631E−04, A8 = 3.79064E−05
A10 = −1.03815E−06, A12 = 0.00000E+00, A14 = 0.00000E+00, A16 = 0.00000E+00
Surface No. 15
K = 0.00000E+00, A4 = 4.08390E−03, A6 = −9.67088E−04, A8 = 6.14835E−05
A10 = −1.41397E−06, A12 = 0.00000E+00, A14 = 0.00000E+00, A16 = 0.00000E+00

TABLE 6
(Various data)
Zooming ratio 2.79675

| | Wide-angle | Middle | Telephoto |
|---|---|---|---|
| | limit | position | limit |
| Focal length | 5.1316 | 8.5847 | 14.3519 |
| F-number | 3.60070 | 4.85783 | 6.69783 |
| View angle | 39.0072 | 24.6888 | 14.9791 |
| Image height | 3.5000 | 3.9000 | 3.9000 |
| Overall length | 18.9248 | 17.8858 | 19.0000 |
| of lens system | | | |
| BF | 0.00000 | 0.00000 | 0.00000 |
| d4 | 6.2704 | 2.8190 | 0.3000 |
| d11 | 2.2255 | 2.0007 | 2.0906 |
| d13 | 1.1756 | 3.8128 | 7.3561 |
| Entrance pupil | 4.8984 | 3.4770 | 1.9163 |
| position | | | |
| Exit pupil | −8.4139 | −14.9371 | −34.5965 |
| position | | | |
| Front principal | 6.9260 | 7.1728 | 10.3108 |
| points position | | | |
| Back principal | 13.8631 | 9.4382 | 4.6270 |
| points position | | | |

Zoom lens unit data

| | | | Overall | Front | Back |
|---|---|---|---|---|---|
| | Initial | | length | principal | principal |
| Lens | surface | Focal | of lens | points | points |
| unit | No. | length | unit | position | position |
| 1 | 1 | −10.25701 | 2.66080 | 0.55110 | 1.38606 |
| 2 | 5 | 4.70022 | 2.70330 | 0.85391 | 1.20931 |
| 3 | 12 | −6.04262 | 0.60000 | 0.07447 | 0.28972 |
| 4 | 14 | 16.00817 | 2.71920 | 0.42986 | 1.33483 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd |
|---|---|---|---|---|
| Object surface | ∞ | | | |
| 1* | 5000.00000 | 0.30000 | 1.77200 | 50.0 |
| 2* | 3.92920 | 2.11050 | | |
| 3* | 6.56820 | 1.49590 | 1.99537 | 20.7 |
| 4* | 9.28220 | Variable | | |
| 5(Diaphragm) | ∞ | 0.00000 | | |
| 6* | 3.45850 | 2.34140 | 1.58332 | 59.1 |
| 7* | −6.45810 | 0.17800 | | |
| 8* | −120.15100 | 0.30000 | 1.82115 | 24.1 |
| 9* | 6.07700 | 0.70000 | | |
| 10 | 8.29340 | 0.70000 | 1.48749 | 70.4 |
| 11 | −82.75500 | Variable | | |
| 12* | −5.89750 | 0.30000 | 1.68966 | 53.0 |
| 13* | −183.95060 | Variable | | |
| 14* | 15.52000 | 1.76570 | 1.82115 | 24.1 |
| 15* | −34.19410 | 0.50680 | | |
| 16 | ∞ | 0.78000 | 1.51680 | 64.2 |
| 17 | ∞ | 0.57000 | | |
| 18 | ∞ | (BF) | | |
| Image surface | ∞ | | | |

TABLE 8
(Aspherical data)

Surface No. 1
K = 0.00000E+00, A4 = 3.90750E−03, A6 = −1.83363E−04, A8 = −3.83285E−06
A10 = 6.57392E−07, A12 = −2.61105E−08, A14 = 3.83518E−10, A16 = 0.00000E+00
Surface No. 2
K = 0.00000E+00, A4 = 2.08212E−03, A6 = 1.74409E−04, A8 = −1.00933E−05
A10 = −8.33108E−08, A12 = −2.03446E−07, A14 = 8.33213E−09, A16 = 0.00000E+00
Surface No. 3
K = 0.00000E+00, A4 = −1.60753E−03, A6 = 2.02394E−04, A8 = 3.62089E−07
A10 = −1.59637E−07, A12 = −2.83529E−08, A14 = 5.77291E−10, A16 = 0.00000E+00
Surface No. 4
K = 0.00000E+00, A4 = −1.24130E−03, A6 = 1.44264E−04, A8 = 1.65267E−06
A10 = 9.85067E−07, A12 = −2.65734E−07, A14 = 1.85695E−08, A16 = −5.46013E−10
Surface No. 6
K = 0.00000E+00, A4 = −1.88072E−03, A6 = −5.68829E−04, A8 = −4.99484E−05
A10 = −1.38712E−05, A12 = −3.02234E−06, A14 = −5.31617E−08, A16 = 0.00000E+00
Surface No. 7
K = 0.00000E+00, A4 = −3.18367E−03, A6 = −1.45779E−03, A8 = 1.32652E−04
A10 = −2.52055E−06, A12 = −3.21102E−07, A14 = −1.35163E−07, A16 = 0.00000E+00
Surface No. 8
K = 0.00000E+00, A4 = 1.18266E−04, A6 = 3.04171E−04, A8 = −5.93575E−05
A10 = 1.53240E−05, A12 = 1.84962E−06, A14 = 5.70940E−07, A16 = 0.00000E+00
Surface No. 9
K = 0.00000E+00, A4 = 7.05508E−03, A6 = 2.18176E−03, A8 = −1.78969E−04
A10 = 5.69360E−05, A12 = 0.00000E+00, A14 = 0.00000E+00, A16 = 0.00000E+00
Surface No. 12
K = 0.00000E+00, A4 = 5.45200E−03, A6 = 1.65428E−03, A8 = −6.35396E−04
A10 = 4.75904E−05, A12 = −4.72304E−07, A14 = −1.11157E−07, A16 = 0.00000E+00
Surface No. 13
K = 0.00000E+00, A4 = 7.49531E−03, A6 = 8.49725E−04, A8 = −3.76356E−04
A10 = 9.60903E−06, A12 = 2.62257E−06, A14 = −1.12761E−07, A16 = 0.00000E+00
Surface No. 14
K = 0.00000E+00, A4 = 3.34269E−03, A6 = −6.88088E−04, A8 = 8.27574E−05
A10 = −5.31617E−06, A12 = 1.76045E−07, A14 = −2.35539E−09, A16 = −3.21629E−13
Surface No. 15
K = 0.00000E+00, A4 = 6.37793E−03, A6 = −1.30747E−03, A8 = 1.44130E−04
A10 = −8.63754E−06, A12 = 2.58416E−07, A14 = −2.52450E−09, A16 = −2.05741E−11

TABLE 9
(Various data)
Zooming ratio 3.68016

| | Wide-angle | Middle | Telephoto |
|---|---|---|---|
| | limit | position | limit |
| Focal length | 3.9546 | 7.5800 | 14.5534 |
| F-number | 2.91339 | 4.37741 | 6.17294 |
| View angle | 45.3089 | 27.4538 | 14.7281 |
| Image height | 3.5000 | 3.9000 | 3.9000 |
| Overall length | 24.0064 | 24.0062 | 24.0063 |
| of lens system | | | |
| BF | 0.00000 | 0.00000 | 0.00000 |
| d4 | 8.4956 | 4.3177 | 0.3000 |
| d11 | 1.9354 | 1.5575 | 3.5147 |
| d13 | 1.5271 | 6.0827 | 8.1433 |
| Entrance pupil | 4.4429 | 3.6033 | 2.1887 |
| position | | | |
| Exit pupil | −10.9931 | −38.1204 | −215.5192 |
| position | | | |
| Front principal | 6.9840 | 9.6747 | 15.7593 |
| points position | | | |
| Back principal | 20.1227 | 16.3909 | 9.4341 |
| points position | | | |

Zoom lens unit data

| | | | Overall | Front | Back |
|---|---|---|---|---|---|
| | Initial | | length | principal | principal |
| Lens | surface | Focal | of lens | points | points |
| unit | No. | length | unit | position | position |
| 1 | 1 | −7.56412 | 3.90640 | −0.12426 | 0.87469 |
| 2 | 5 | 5.63316 | 4.21940 | 0.28424 | 1.34328 |
| 3 | 12 | −8.84063 | 0.30000 | −0.00588 | 0.11644 |
| 4 | 14 | 13.21156 | 3.05250 | 0.30761 | 1.35373 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd |
|---|---|---|---|---|
| Object surface | ∞ | | | |
| 1* | 2000.00000 | 0.30000 | 1.80470 | 41.0 |
| 2* | 4.46820 | 2.30230 | | |
| 3* | 9.27140 | 1.25230 | 2.10200 | 16.8 |
| 4* | 15.10240 | Variable | | |
| 5(Diaphragm) | ∞ | −0.20000 | | |
| 6* | 3.76220 | 2.33520 | 1.51845 | 70.0 |
| 7* | −33.05820 | 0.15000 | | |
| 8 | 4.88750 | 0.30000 | 2.00272 | 19.3 |
| 9 | 3.44170 | 0.62470 | | |
| 10 | 158.04580 | 1.00390 | 1.49700 | 81.6 |
| 11 | −4.68280 | Variable | | |
| 12* | −6.52240 | 0.60000 | 1.52996 | 55.8 |
| 13* | 22.09680 | Variable | | |
| 14* | −153.43180 | 1.61860 | 1.63550 | 23.9 |
| 15* | −7.26810 | 0.25000 | | |
| 16 | ∞ | 0.60000 | 1.51680 | 64.2 |
| 17 | ∞ | 0.48600 | | |
| 18 | ∞ | (BF) | | |
| Image surface | ∞ | | | |

TABLE 11
(Aspherical data)

Surface No. 1
K = 0.00000E+00, A4 = 1.50772E−03, A6 = −5.75984E−05, A8 = −1.01659E−06
A10 = 1.48931E−07, A12 = −4.86993E−09, A14 = 5.62289E−11, A16 = 0.00000E+00
Surface No. 2
K = 0.00000E+00, A4 = 2.67244E−04, A6 = 8.28725E−05, A8 = −4.40021E−06
A10 = −3.50905E−07, A12 = 2.05968E−08, A14 = −8.93589E−10, A16 = 0.00000E+00
Surface No. 3
K = 0.00000E+00, A4 = −1.24572E−03, A6 = 9.25981E−05, A8 = −9.21185E−07
A10 = 2.27451E−09, A12 = −5.94353E−09, A14 = 3.28693E−10, A16 = 0.00000E+00
Surface No. 4
K = 0.00000E+00, A4 = −1.23337E−03, A6 = 1.08717E−04, A8 = −1.66164E−05
A10 = 2.90664E−06, A12 = −2.69613E−07, A14 = 1.22132E−08, A16 = −2.03647E−10
Surface No. 6
K = 1.05042E−02, A4 = −1.76137E−03, A6 = 9.70894E−05, A8 = −1.07727E−04
A10 = 2.47820E−05, A12 = −2.36897E−06, A14 = −2.85030E−08, A16 = −1.53787E−09
Surface No. 7
K = 0.00000E+00, A4 = 2.83521E−03, A6 = 4.16546E−05, A8 = −5.67912E−05
A10 = 2.53603E−06, A12 = 1.29901E−06, A14 = −2.17300E−07, A16 = 0.00000E+00
Surface No. 12
K = 0.00000E+00, A4 = 8.14297E−03, A6 = −7.00956E−04, A8 = −2.17815E−04
A10 = 5.91358E−05, A12 = −2.13096E−06, A14 = −3.08690E−07, A16 = 0.00000E+00
Surface No. 13
K = 0.00000E+00, A4 = 7.88839E−03, A6 = −7.49305E−04, A8 = −1.11270E−04
A10 = 3.16267E−05, A12 = −1.20777E−06, A14 = −1.05583E−07, A16 = 0.00000E+00
Surface No. 14
K = 0.00000E+00, A4 = 5.27461E−03, A6 = −1.27794E−03, A8 = 1.53107E−04
A10 = −1.05585E−05, A12 = 4.27127E−07, A14 = −9.26534E−09, A16 = 7.97203E−11
Surface No. 15
K = 0.00000E+00, A4 = 1.48555E−02, A6 = −2.69354E−03, A8 = 2.30908E−04
A10 = −8.35228E−06, A12 = −3.40349E−08, A14 = 1.07492E−08, A16 = −2.14623E−10

TABLE 12
(Various data)
Zooming ratio 4.61002

| | Wide-angle | Middle | Telephoto |
|---|---|---|---|
| | limit | position | limit |
| Focal length | 3.7400 | 8.0300 | 17.2414 |
| F-number | 2.81152 | 4.33472 | 7.17656 |
| View angle | 48.0084 | 25.6855 | 12.5614 |
| Image height | 3.5000 | 3.9000 | 3.9000 |
| Overall length | 26.9004 | 24.5219 | 28.4999 |
| of lens system | | | |
| BF | 0.00000 | 0.00000 | 0.00000 |
| d4 | 11.0918 | 4.4157 | 0.5000 |
| d11 | 2.8282 | 2.2554 | 2.4651 |
| d13 | 1.3574 | 6.2278 | 13.9118 |
| Entrance pupil | 4.9840 | 3.7025 | 2.3298 |
| position | | | |
| Exit pupil | −15.8977 | −202.2660 | 31.0283 |
| position | | | |
| Front principal | 7.8480 | 11.4138 | 29.1454 |
| points position | | | |
| Back principal | 23.2305 | 16.5265 | 11.2380 |
| points position | | | |

Zoom lens unit data

| | | | Overall | Front | Back |
|---|---|---|---|---|---|
| | Initial | | length | principal | principal |
| Lens | surface | Focal | of lens | points | points |
| unit | No. | length | unit | position | position |
| 1 | 1 | −8.67195 | 3.85460 | −0.47564 | 0.20755 |
| 2 | 5 | 6.15514 | 4.21380 | 1.06436 | 1.70080 |
| 3 | 12 | −9.43395 | 0.60000 | 0.08873 | 0.29939 |
| 4 | 14 | 11.95409 | 2.46860 | 1.03443 | 1.87203 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd |
|---|---|---|---|---|
| Object surface | ∞ | | | |
| 1* | −85.53100 | 0.30000 | 1.77200 | 50.0 |
| 2* | 4.18250 | 2.09220 | | |
| 3* | 7.61230 | 1.06050 | 1.99537 | 20.7 |
| 4* | 11.40670 | Variable | | |
| 5(Diaphragm) | ∞ | 0.00000 | | |
| 6* | 3.31820 | 2.42690 | 1.58332 | 59.1 |
| 7* | −6.61490 | 0.17800 | | |
| 8* | −63.63220 | 0.30000 | 1.82145 | 24.1 |
| 9* | 6.03460 | 0.60000 | | |
| 10 | 5.71460 | 0.60000 | 1.51951 | 67.2 |
| 11 | 56.61440 | Variable | | |
| 12* | −5.65620 | 0.30000 | 1.52524 | 66.6 |
| 13* | 40.02170 | Variable | | |
| 14* | −100.16870 | 1.11790 | 1.68633 | 29.9 |
| 15* | 155.54390 | 0.50750 | | |
| 16 | ∞ | 0.78000 | 1.51680 | 64.2 |
| 17 | ∞ | 0.57000 | | |
| 18 | ∞ | (BF) | | |
| Image surface | ∞ | | | |

TABLE 14
(Aspherical data)

Surface No. 1
K = 0.00000E+00, A4 = 3.56941E−03, A6 = −1.80343E−04, A8 = −3.66885E−06
A10 = 6.69940E−07, A12 = −2.59532E−08, A14 = 3.51323E−10, A16 = 0.00000E+00
Surface No. 2
K = 0.00000E+00, A4 = 2.54695E−03, A6 = 1.74768E−04, A8 = −1.02616E−05
A10 = −2.94627E−08, A12 = −1.99153E−07, A14 = 9.01434E−09, A16 = 0.00000E+00
Surface No. 3
K = 0.00000E+00, A4 = −1.86615E−03, A6 = 2.06044E−04, A8 = −9.56649E−07
A10 = −2.18028E−07, A12 = −2.59837E−08, A14 = 9.10889E−10, A16 = 0.00000E+00
Surface No. 4
K = 0.00000E+00, A4 = −1.69434E−03, A6 = 1.17469E−04, A8 = 1.59675E−06
A10 = 1.01129E−06, A12 = −2.64279E−07, A14 = 1.89235E−08, A16 = −4.81108E−10
Surface No. 6
K = 0.00000E+00, A4 = −2.01736E−03, A6 = −5.68191E−04, A8 = −3.62999E−05
A10 = −1.32762E−05, A12 = −4.00037E−06, A14 = −4.92242E−08, A16 = 0.00000E+00
Surface No. 7
K = 0.00000E+00, A4 = −3.49515E−03, A6 = −1.52916E−03, A8 = 1.19191E−04
A10 = 3.85920E−06, A12 = −5.08098E−07, A14 = −1.25805E−07, A16 = 0.00000E+00
Surface No. 8
K = 0.00000E+00, A4 = 9.17127E−05, A6 = 3.01234E−04, A8 = −2.50039E−05
A10 = 2.21128E−05, A12 = 1.76742E−06, A14 = 5.44738E−07, A16 = 0.00000E+00
Surface No. 9
K = 0.00000E+00, A4 = 7.17735E−03, A6 = 2.53291E−03, A8 = −9.43116E−05
A10 = 8.99899E−05, A12 = 0.00000E+00, A14 = 0.00000E+00, A16 = 0.00000E+00
Surface No. 12
K = 0.00000E+00, A4 = 5.05349E−03, A6 = 1.96014E−03, A8 = −5.43580E−04
A10 = 3.24432E−05, A12 = −4.82202E−07, A14 = −1.14823E−07, A16 = 0.00000E+00
Surface No. 13
K = 0.00000E+00, A4 = 9.56957E−03, A6 = 1.23036E−03, A8 = −3.71554E−04
A10 = −7.88431E−07, A12 = 2.36658E−06, A14 = −1.12307E−07, A16 = 0.00000E+00
Surface No. 14
K = 0.00000E+00, A4 = 1.50364E−03, A6 = −7.02497E−04, A8 = 8.60966E−05
A10 = −5.24399E−06, A12 = 1.67110E−07, A14 = −3.22167E−09, A16 = −5.09297E−11
Surface No. 15
K = 0.00000E+00, A4 = −1.40911E−04, A6 = −1.19818E−03, A8 = 1.46974E−04
A10 = −8.64388E−06, A12 = 2.51825E−07, A14 = −2.89908E−09, A16 = −4.39330E−11

TABLE 15
(Various data)
Zooming ratio 3.68617

| | Wide-angle | Middle | Telephoto |
|---|---|---|---|
| | limit | position | limit |
| Focal length | 4.0944 | 7.8618 | 15.0927 |
| F-number | 2.91231 | 4.06887 | 6.17623 |
| View angle | 47.3997 | 28.1903 | 15.5667 |
| Image height | 3.3000 | 3.7000 | 3.7000 |
| Overall length | 22.8187 | 20.3549 | 22.3938 |
| of lens system | | | |
| BF | 0.00000 | 0.00000 | 0.00000 |
| d4 | 8.6340 | 3.3066 | 0.3000 |
| d11 | 1.5757 | 1.6142 | 1.9896 |
| d13 | 1.7760 | 4.6011 | 9.2712 |
| Entrance pupil | 4.3070 | 3.1846 | 2.0672 |
| position | | | |
| Exit pupil | −7.0232 | −9.4777 | −13.3359 |
| position | | | |
| Front principal | 6.0332 | 4.5503 | 0.0138 |
| points position | | | |
| Back principal | 18.7799 | 12.5300 | 7.2505 |
| points position | | | |

Zoom lens unit data

| | | | Overall | Front | Back |
|---|---|---|---|---|---|
| | Initial | | length | principal | principal |
| Lens | surface | Focal | of lens | points | points |
| unit | No. | length | unit | position | position |
| 1 | 1 | −7.51099 | 3.45270 | −0.27224 | 0.35492 |
| 2 | 5 | 5.27161 | 4.10490 | 0.34861 | 1.40201 |
| 3 | 12 | −9.41397 | 0.30000 | 0.02430 | 0.12805 |
| 4 | 14 | −88.61947 | 2.40540 | 0.25922 | 0.98114 |

The following Table 16 shows the corresponding values to the individual conditions in the zoom lens systems of each of Numerical Examples.

TABLE 16
(Values corresponding to conditions)

| | | Numerical Example | | | | |
|---|---|---|---|---|---|---|
| | Condition | 1 | 2 | 3 | 4 | 5 |
| (1) | vd_{4G} | 24.10 | 27.00 | 24.10 | 23.90 | 29.90 |
| (2) | ω_{W} | 47.42 | 39.01 | 45.31 | 48.01 | 47.40 |
| (3) | f_{W}/T_{L1} | 12.47 | 17.11 | 13.18 | 12.47 | 13.65 |
| (4) | T_{ESC}/T_{OIS} | 4.87 | 4.51 | 4.03 | 7.36 | 13.68 |
| (5) | f_{G1}/(H_{T} × Z) | −0.53 | −0.94 | −0.53 | −0.48 | −0.52 |
| (6) | √(−f_{G1} × f_{G2})/(H_{T} × Z) | 0.45 | 0.64 | 0.45 | 0.41 | 0.44 |

The zoom lens system according to the present invention is applicable to a digital input device, such as a digital camera, a mobile terminal device such as a smart-phone, a surveillance camera in a surveillance system, a Web camera or a vehicle-mounted camera. In particular, the zoom lens system according to the present invention is suitable for a photographing optical system where high image quality is required like in a digital camera.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. A zoom lens system having a plurality of lens units, each lens unit being composed of at least one lens element, the zoom lens system, in order from an object side to an image side, comprising:
a first lens unit having negative optical power;
a second lens unit having positive optical power;
a third lens unit having negative optical power; and
a subsequent lens unit containing at least a fourth lens unit, wherein
in zooming from a wide-angle limit to a telephoto limit at the time of image taking, intervals between the individual lens units vary and the fourth lens unit is fixed relative to an image surface, and wherein
the following conditions (1) and (2) are satisfied:
vd_{4G}<40 (1)
ω_{w}>34 (2)
where,
vd_{4G} is an Abbe number to the d-line of a lens element constituting the fourth lens unit, and
ω_{w} is a half view angle (°) at a wide-angle limit.

2. The zoom lens system as claimed in claim 1, wherein the following condition (3) is satisfied:
3<f_{w}/T_{L1}<70 (3)
where,
f_{w} is a focal length of the entire system at a wide-angle limit, and
T_{L1} is an optical axial thickness of a lens element located closest to the object side among the lens elements constituting the first lens unit.

3. The zoom lens system as claimed in claim 1, having:
an escaping lens unit that, at the time of retracting, escapes along an axis different from that at the time of image taking; and
an image blur compensating lens unit that moves in a direction perpendicular to an optical axis in order to optically compensate image blur, wherein
the following condition (4) is satisfied:
3.5<T_{ESC}/T_{OIS}<18.0 (4)
where,
T_{ESC} is an optical axial thickness of the escaping lens unit, and
T_{OIS} is an optical axial thickness of the image blur compensating lens unit.

4. The zoom lens system as claimed in claim 1, wherein the following condition (5) is satisfied:
−1.5<f_{G1}/(H_{T}×Z)<−0.3 (5)
where,
f_{G1} is a focal length of the first lens unit,
H_{T} is an image height at a telephoto limit,
Z is a value expressed by the following formula,
Z=f_{T}/f_{w}
f_{T} is a focal length of the entire system at a telephoto limit, and
f_{w} is a focal length of the entire system at a wide-angle limit.

5. The zoom lens system as claimed in claim 1, wherein the following condition (6) is satisfied:
0.3<√(−f_{G1}×f_{G2})/(H_{T}×Z)<2.0 (6)
where,
f_{G1} is a focal length of the first lens unit,
f_{G2} is a focal length of the second lens unit,
H_{T} is an image height at a telephoto limit,
Z is a value expressed by the following formula,
Z=f_{T}/f_{w}
f_{T} is a focal length of the entire system at a telephoto limit, and
f_{w} is a focal length of the entire system at a wide-angle limit.

6. The zoom lens system as claimed in claim 1, wherein the first lens unit is composed of two or more lens elements.

7. The zoom lens system as claimed in claim 1, wherein a lens unit located closest to the image side among the lens units constituting the subsequent lens unit is composed of one lens element.

8. The zoom lens system as claimed in claim 1, having
a focusing lens unit that moves relative to the image surface in focusing from an infinity in-focus condition to a close-object in-focus condition, wherein
the focusing lens unit moves to the image side along an optical axis in focusing.

9. The zoom lens system as claimed in claim 8, wherein the focusing lens unit is composed of one lens element.

10. The zoom lens system as claimed in claim 3, wherein the image blur compensating lens unit is composed of one lens element.

11. The zoom lens system as claimed in claim 7, wherein the lens unit located closest to the image side is fixed relative to the image surface in zooming from a wide-angle limit to a telephoto limit at the time of image taking.

12. An imaging device capable of outputting an optical image of an object as an electric image signal, comprising:
a zoom lens system that forms an optical image of the object; and
an image sensor that converts the optical image formed by the zoom lens system into the electric image signal, wherein
the zoom lens system is a zoom lens system as claimed in claim 1.

13. A camera for converting an optical image of an object into an electric image signal and then performing at least one of displaying and storing of the converted image signal, comprising
an imaging device including a zoom lens system that forms an optical image of the object and an image sensor that converts the optical image formed by the zoom lens system into the electric image signal, wherein
the zoom lens system is a zoom lens system as claimed in claim 1.
